(19) United States
(12) Patent Application Publication
(10) Pub. No.: US 2011/0227843 A1
(43) Pub. Date: Sep. 22, 2011

(54) CONTROL SYSTEM FOR CONTROLLING MOBILE DEVICE OF AUTOMOBILE

(75) Inventor: Wen-Chieh WANG, New Taipei City (TW)

(73) Assignee: Wonde Proud Technology Co., Ltd.

(21) Appl. No.: 13/045,589

(22) Filed: Mar. 11, 2011

(30) Foreign Application Priority Data
Mar. 16, 2010 (TW) 099204596

(51) Int. Cl. G06F 3/041

(52) U.S. Cl. 345/173

(57) ABSTRACT

A control system for controlling a mobile device of an automobile includes a signal transiting device (3), a vehicle monitor (11) and a mobile device (2). The mobile device (2) displays an image (I1) via a screen (21) thereon, and the signal transiting device (3) receives the image (11) of the mobile device (2) and transmits the received image (I1) to display on the vehicle monitor (11) of an automobile (1). When a user proceeds to operate the image (I1) via the vehicle monitor (11) of the automobile (1), the signal transiting device (3) produces a control signal (S1) according to an operating action of the user. Therefore, the signal transiting device (3) transmits the produced control signal (S1) to the mobile device (2), and the mobile device (2) can be controlled to execute functions according to the control signal (S1).

### BACKGROUND OF THE INVENTION

1. Field of the Invention

The invention related to a control system for controlling a mobile device, and in particular to a control system for controlling a mobile device in an automobile.

2. Description of the Prior Art

Electrical device is very popular today, especially many kinds of mobile device, such as mobile phone, global positioning system (GPS) device, MP3 player, etc, are used very commonly and generally around people.

As mentioned above, an intelligent mobile device, especially a smart cell phone (or smart phone), is the most popular product among those mobile devices, it is due to the powerful functions, the broad applications and the convenient use provided by the smart phone. For example, if a user has a smart phone, he or she can then use GPS function, play MP3s, take photos, surf on internet, receive e-mails, make phone calls and etc, via using the smart phone. User can reach different purposes by using the single smart phone instead of many other types of mobile device each is only capable of one function.

This kind of mobile device mainly has a touch screen, and installs therein a high standard operating system (OS), for example, Android, developed by Google, WinCE, developed by Microsoft, or Iphone OS, developed by Apple. It is convenient that user can touch icons of image displayed on the touch screen directly to control the mobile device to execute functions according to the touched icon.

The intelligent mobile device mentioned above is capable of many functions, wherein, taking phone call, GPS function and playing MP3 are the most favorite functions for people, especially for people who take automobile as a transport. It is because user can simultaneously use those functions via the intelligent mobile device to replace navigator and audio in the automobile. However, it may also cause dangerous accidents involved with using those functions via the intelligent mobile device while the automobile is moving.

Although the screen of the intelligent mobile device is usually bigger than that of a general mobile device, but the screen of the intelligent mobile device is still smaller than a vehicle monitor of the automobile. In other words, it is inconvenient and dangerous for user to watch the screen of the intelligent mobile device in the automobile. If user distracts his/her mind from the road forward to the screen of the intelligent mobile device when driving, the incidence of car accidents may more likely occur.

Moreover, if the user wants to use GPS function via the intelligent mobile device, he or she should proceed to set tedious procedures on the intelligent mobile device, such as locating, finding destination, setting route and planning. After finishing planning, the user should watch the route displayed on the screen of the intelligent mobile device continuously, and it causes more inconvenient. Furthermore, if the user takes phone calls, switches MP3 files or watches lyrics on the screen of the intelligent mobile device when driving, then it may cause the same accidents mentioned above.

The operating action for the intelligent mobile device is performed by touching the icons of the image displayed on the touch screen of the intelligent mobile device directly, because the size of the touch screen is not big enough, the size of the icons have limitation. Therefore, the operating action of touching is difficult to be done accurately by the user while the automobile is moving.

In view of this, researchers of this filed spend efforts in developing a novelty system, which implements powerful functions and without any danger for user to use mobile device in the automobile while the automobile is moving.

### SUMMARY OF THE INVENTION

The invention is to provide a control system for controlling a mobile device of an automobile, a vehicle monitor of the automobile can display an image of the mobile device, and the control system is to control the mobile device according to an operating action to the image displayed on the vehicle monitor of the automobile.

According to the present invention, the control system includes a signal transiting device, a vehicle monitor and a mobile device. The mobile device displays an image via a screen thereon, and the signal transiting device receives the image of the mobile device and transmits the received image to display on the vehicle monitor of an automobile. When a user proceeds to operate the image via the vehicle monitor of the automobile, the signal transiting device produces a control signal according to an operating action of the user. Therefore, the signal transiting device transmits the produced control signal to the mobile device, and the mobile device can be controlled to execute functions according to the control signal.

In comparison with prior art, the present invention has advantageous features as follow. First, size of the vehicle monitor is bigger than that of the screen of the mobile device, and the image displayed on the screen of the mobile device can be transmitted to display on the vehicle monitor. Therefore, a user can see the image displayed on the vehicle monitor instead of the screen which has small size. Also, the user needs not to hold the mobile device with hands.

Second, if the screen of the mobile device and the vehicle monitor of the automobile are both touchable, then the user can touch icons of the image displayed on the vehicle monitor, and the signal transiting device transmits a control signal according to functions of the touched icon to the mobile device, so as to control the mobile device to execute functions according to the control signal.

### BRIEF DESCRIPTION OF THE DRAWINGS

FIG. 1 is a schematic view of a system of a preferred embodiment according to the present invention;

FIG. 2 is a block view of a preferred embodiment according to the present invention;

FIG. 3 is a schematic view of a system of a second embodiment according to the present invention;

FIG. 4 is a flow chart of a preferred embodiment according to the present invention.

### DETAIL DESCRIPTION OF THE INVENTION

The preferred embodiments of the present invention will be described in more detail with reference to the accompanying drawings. The drawings are provided for illustrating only, not intended for limiting the present invention.

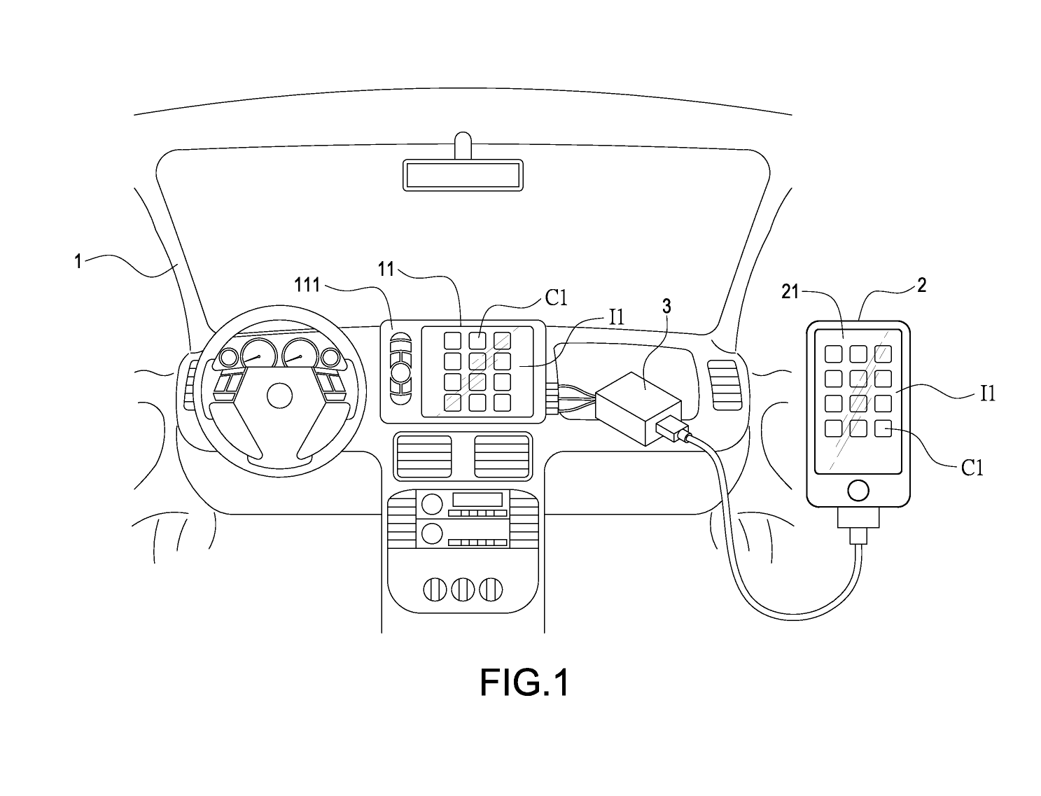

FIG. 1 is a schematic view of a system of a preferred embodiment according to the present invention. The system of the present invention is mainly used in a vehicle such as an automobile 1 (the automobile 1 is used to as an example thereinafter). The automobile 1 has a vehicle monitor 11 therein, the vehicle monitor 11 connects to a signal transiting device 3, and the signal transiting device 3 connects to a mobile device 2, namely, the vehicle monitor 11 connects with the mobile device 2 via the signal transiting device 3.

Therefore, an image I1 displayed on a screen 21 of the mobile device 2 can then be transmitted to display on the vehicle monitor 11 of the automobile 1. Screen size of the vehicle monitor 11 of the automobile 1 is usually bigger than that of the screen 21 of the mobile device 2, it is more convenient for a user to see the image I1 displayed on the mobile device 2 and to conduct operation according to the image.

The mobile device 2 is an intelligent mobile device 2, such as a smart phone, and the screen 21 of the mobile device 2 is mainly a touch screen. The image I1 displayed on the screen 21 includes at least one icon C1 which is touchable, the image I1 and whole icons C1 therein is totally transmitted to display on the vehicle monitor 11 when a connection is established between the vehicle monitor 11 and the mobile device 2 via the signal transiting device 3. Therefore, the user can select anyone of the icons C1 on the image I1 displayed on the vehicle monitor 11 directly, so as to control the mobile device 2 to execute functions according to the selected icon C1.

The image I1 is fetched from the screen 21 by the signal transiting device 3, the signal transiting device 3 receives the image I1 to process, and then transmits the processed image I1 to the vehicle monitor 11 to display. When processing the image I1, the signal transiting device 3 can add a hotkey area 111 to the image I1. Each hotkey of the hotkey area 111 can be set with a corresponding specific function of the mobile device 2, and the specific function can be, for example, changing ringing tone, calculator or currency exchanging rates. When a hotkey of the hotkey area 111 of the vehicle monitor 11 is selected by the user, the mobile device 2 is then trigged to execute the function according to the selected hotkey.

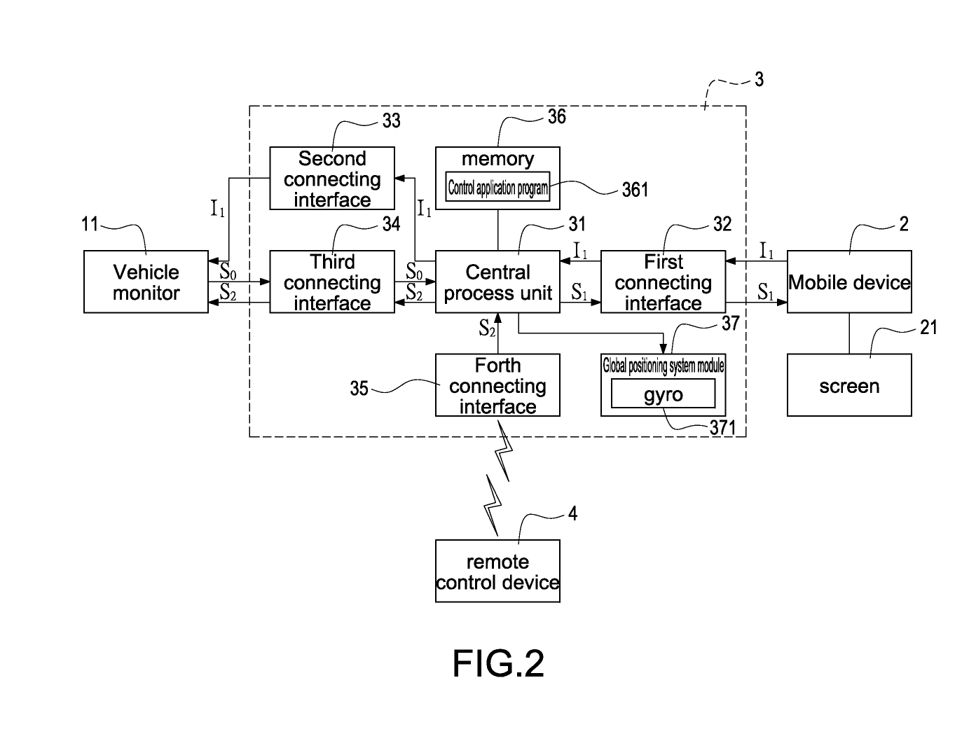

FIG. 2 is a block view of a preferred embodiment according to the present invention. The signal transiting device 3 includes a central process unit (CPU) 31, a first connecting interface 32, a second connecting interface 33 and a third connecting interface 34. The CPU 31 electrically connects to the first connecting interface 32, the second connecting interface 33 and the third connecting interface 34, so as to transmit and process images and signals between the mobile device 2 and the vehicle monitor 11.

The first connecting interface 32 can be, for example, a universal serial bus (USB) interface, a blue tooth interface or a WIFI interface. The signal transiting device 3 connects to the mobile device 2 to receive the image I1 of the mobile device 2 via the first connecting interface 32, and the received image I1 is transmitted via the first connecting interface 32 to the CPU 31 to process. For example, the CPU 31 can produce the hotkey area 111 and combine the hotkey area 111 to the image I1, and the hotkey area 111 will be located beside the image I1 and displayed on the vehicle monitor 11.

The second connecting interface 33 is a RCA terminal, and signal transiting device 3 connects to the vehicle monitor 11 via the second connecting interface 33. When receiving the processed image I1 from the CPU 31, the second connecting interface 33 transmits the processed image I1 to the vehicle monitor 11 to display.

When one of the icons C1 of the image I1 displayed on the vehicle monitor 11 is selected by a user through an operating action, the vehicle monitor 11 produces an operating signal S0 according to the selected icon C1, and output the operating signal S0 to the CPU 31 of the signal transiting device 3 via the third connecting interface 34. Moreover, the third connecting interface 34 can be any kind of connecting interfaces capable of transmitting digital signal, such as a universal asynchronous receiver/transmitter (UART) interface, but not intended to limit the protection scope of the present invention.

The CPU 31 receives the operating signal S0 and determines content of the operating signal S0, wherein, the content of the operating signal S0 is according to the function of the selected icon C1. Finally, the CPU 31 produces a control signal S1 according to the content of the operating signal S0, and the CPU 31 transmits the control signal S1 to the mobile device 2 via the first connecting interface 32, so as to control the mobile device 2 to execute functions according to the control signal S1.

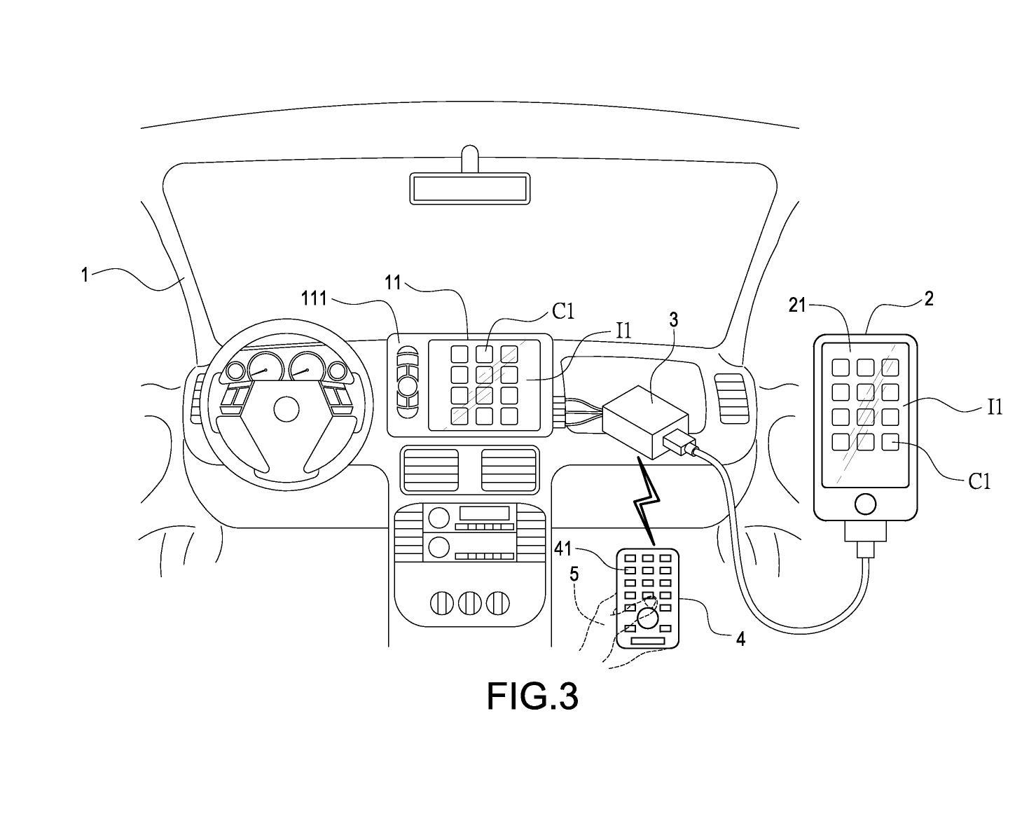

FIG. 3 is a schematic view of a system of a second embodiment according to the present invention. The vehicle monitor 11 of the automobile 1 is a touch screen 11, the operating action mentioned above is to touch directly one of the icons C1 of the image I1 displayed on the vehicle monitor 11 through user's finger 5.

Therefore, the vehicle monitor 11 outputs the operating signal S0, and the CPU 31 receives the operating signal S0 to produces the control signal S1. It should be mention that, the embodiment mentioned above is just a preferred embodiment of the present invention, if the vehicle monitor 11 of the automobile 1 is incapable of touch input, the user can also select the icon C1 of the image I1 displayed on the vehicle monitor 11 by another operating action, such as using a remote control device 4 shown in FIG. 3.

The signal transiting device 3 further includes a forth connecting interface 35, the forth connecting interface 35 electrically connects to the CPU 31, and receives an external remote control signal S2 send from the remote control device 4 via wireless transmission. The remote control device 4 includes a plurality of buttons 41, the operating action of the user is to press the buttons 41 physically, so as to send the remote control signal S2 to the CPU 31 of the signal transiting device 3 via the forth connecting interface 35.

The forth connecting interface 35 transmits the remote control signal S2 to the CPU 31 to process, and the processed remote control signal S2 is transmitted to the vehicle monitor 11 via the third connecting interface 34. The action above is to simulate the operating action of the user of touching the vehicle monitor 11 directly while the vehicle monitor 11 is capable of touch input. The processed remote control signal S2 also causes the vehicle monitor 11 to produce and output the operating signal S0. Moreover, the forth connecting interface 35 can be, for example, a radio frequency (RF) interface, for communicating signals with the remote control device 4 via wireless RF protocol.

It should be mentioned that, beside transmitting and processing the signals S0, S1 and S2, the signal transiting device 3 can also used as an extending device implemented to extend functions of the mobile device 2 while the signal transiting device 3 connects with mobile device 2. For example, the signal transiting device 3 can further comprise a global positioning system (GPS) module 37 therein, and the GPS module 37 electrically connects to the CPU 31. If the mobile device 2 is a low-level device, lack of network connection function and GPS function, then the user can still use the GPS module 37 to execute GPS function on the mobile device 2 while the mobile device 2 is connected with the signal transiting device 3.

In other embodiment, the GPS module 37 can include a gyro 371 therein, and the mobile device 2 can then execute inertial navigation function via the GPS module 371, instead of re-positioning again and again every time the user locates in a position where is lack of signals (such as in a tunnel). Finally, the mobile device 2 executes the GPS function or the inertial navigation function and transmits produced image to the vehicle monitor 11 to display. Moreover, the signal transiting device 3 can also proposes other extending functions for the mobile device 2, not intend to limit to the above embodiment.

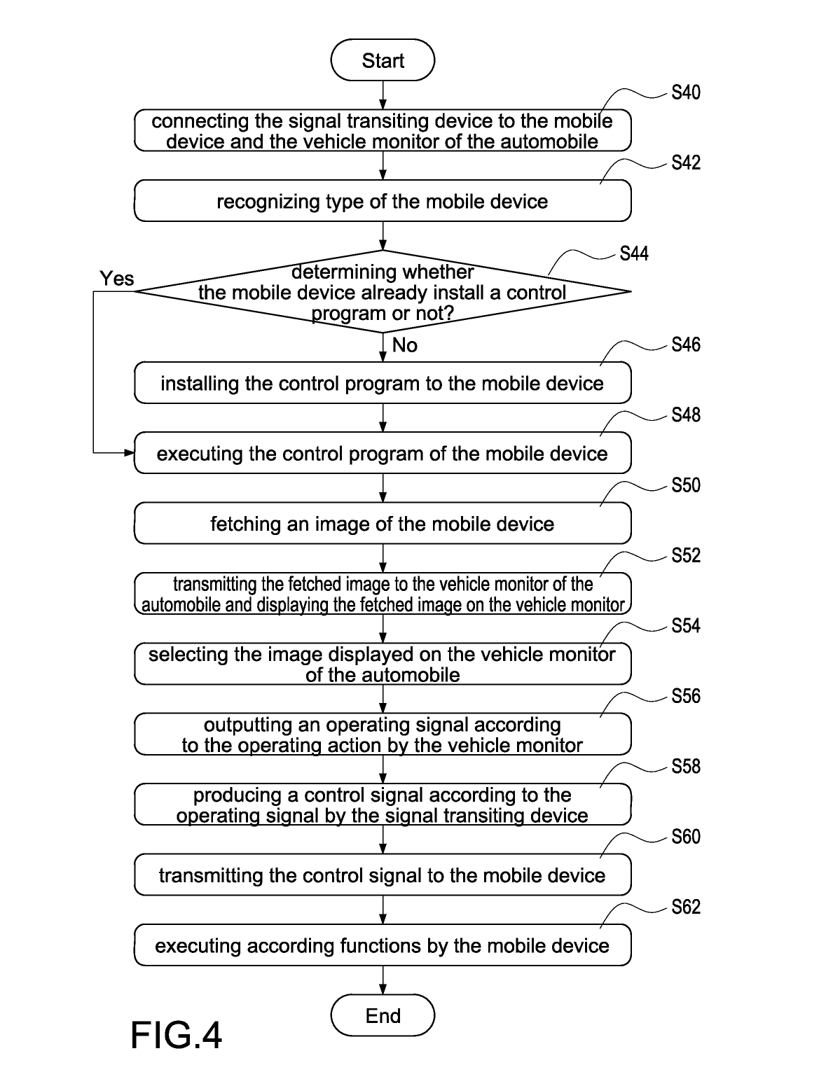

FIG. 4 is a flow chart of a preferred embodiment according to the present invention. First, the signal transiting device 3 connects to the mobile device 2 and the vehicle monitor 11 of the automobile 1 (step S40). Then, the signal transiting device 3 recognizes type of the mobile device 2 automatically (step S42). Referring to FIG. 2, the signal transiting device 3 further includes a memory 36 electrically connected to the CPU 31, and the memory 36 stores a plurality of control programs 361, each of the plurality of control programs 361 is corresponding to different type of mobile device. When recognizing what type the mobile device 2 is, the signal transiting device 3 automatically selects a corresponding control program 361 in the memory 36 which is capable of supporting the mobile device 2 in corresponding type.

For example, if the mobile device 2 is an intelligent cell phone, then the type of operating system (OS) of the mobile device 2 may be WinCE, Iphone OS, Andriod, etc. The signal transiting device 3 selects the control program 361 according to the type of the OS of the mobile device 2 when the type is recognized by the signal transiting device 3.

After all, the signal transiting device 3 communicates data via a communication protocol according to the type of the OS of the mobile device 2 which connects with the signal transiting device 3. For example, if the type of the OS of the mobile device 2 is WINDOWS, then the protocol the signal transiting device 3 used is Activesync. For another example, if the type of the OS of the mobile device 2 is Andriod, or the mobile device is a black berry device, then the protocol the signal transiting device 3 used is the protocol developed by a corporation which produces the mobile device 2.

Before installing the control program 361 to the mobile device 2, the signal transiting device 3 determines whether the mobile device 2 is already installed the control program 361 or not? (step S44). If the mobile device 2 does not install the control program 361 yet, then the signal transiting device 3 installs the control program 361 to the mobile device 2 (step S46). If the mobile device 2 is already installed the control program 361, then the mobile device 2 executes the control program 361 automatically (step S48). Therefore, the control program 361 can fetch the image I1 displayed on the screen 21 of the mobile device 2 (step S50), the signal transiting device 3 receives the fetched image I1, and then transmits the fetched image I1 to the vehicle monitor 11 to display the fetched image I1 on the vehicle monitor 11 (step S52).

When the vehicle monitor 11 displays the fetched image I1, the user can select one of the icons C1 of the image I1 displayed on the vehicle monitor 11 through the operating action, such as touching action by using the finger 5, or remote operating action by using the remote control device 4 (step S54). The vehicle monitor 11 then produces and outputs the operating signal S0 according to the selected icon C1 selected through the operating action of user (step S56). The signal transiting device 3 receives the operating signal S0, and produces the control signal S1 according to the content of the received operating signal S0 (step S58).

Moreover, the control signal S1 is according to the function of the selected icon C1, such as making a phone call, playing MP3 audio or taking photos. Finally, the signal transiting device 3 transmits the control signal S1 to the mobile device 2 (step S60), therefore, the mobile device 2 can then execute functions according to the received control signal S1.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. A control system for controlling a mobile device of an automobile, includes:
a mobile device (2) having a touch screen (21) for displaying an image (I1);
a vehicle monitor (11) of an automobile (1) which is capable of touch input; and
a signal transiting device (3) connected to the mobile device (2) and the vehicle monitor (11), the signal transiting device (3) fetching the image (I1) displayed on the mobile device (2) and transmitting the fetched image (I1) to the vehicle monitor (11) to display;
wherein, the signal transiting device (3) produces a control signal (S1) and transmits the control signal (S1) to the mobile device (2) when the image (I1) displayed on the vehicle monitor (11) is touched, and the mobile device (2) executes functions according to the received control signal (S1).

2. The control system of claim 1, wherein the image (I1) includes a plurality of touchable icons C1, the control signal (S1) according to function of the touched icon C1 of the image (I1) displayed on the vehicle monitor (11).

3. The control system of claim 1, wherein the image (I1) displayed on the vehicle monitor (11) includes a hotkey area (111), and each hotkey of the hotkey area (111) is set with a corresponding specific function of the mobile device (2), the mobile device (2) executing the specific function when the hotkey of the hotkey area (111) is touched.

4. The control system of claim 1, wherein the signal transiting device (3) includes:
a first connecting interface (32) electrically connected to the mobile device (2) for transmitting the image (I1) and the control signal (S1);
a central process unit (31) electrically connected to the first connecting interface (32) for receiving and processing the image (I1);
a second connecting interface (33) electrically connected to the central process unit (31), and the second connecting interface (33) electrically connected to the vehicle monitor (11) of the automobile (1) for transmitting the processed image (I1) to the vehicle monitor (11) to display; and
a third connecting interface (34) electrically connected to the central process unit (31), and the third connecting interface (34) electrically connected to the vehicle monitor (11) of the automobile (1) for receiving an operating signal (S0) produced and outputted by the vehicle monitor (11) when the image displayed on the vehicle monitor (11) is touched;
wherein, the central process unit (31) receives the operating signal (S0) from the vehicle monitor (11) via the third connecting interface (34) to produce the control signal (S1) according to the content of the received operating signal (S0).

5. The control system of claim 4, wherein the signal transiting device (3) further includes a memory (36) electrically connected to the central process unit (31), the memory (36) storing a plurality of control programs (361) therein, each of the plurality of control programs (361) is corresponding to different type of mobile device, the signal transiting device (3) installing one of the plurality of control programs (361) to the mobile device (2) according to the type of the mobile device (2), and the control program (361) is used to fetch the image (I1) displayed on the mobile device (2).

6. The control system of claim 4, wherein the first connecting interface (32) is a universal serial bus (USB) interface, a Bluetooth interface or a WIFI interface.

7. The control system of claim 4, wherein the second connecting interface (33) is a RCA terminal, and the third connecting interface (34) is a universal asynchronous receiver/transmitter (UART) interface.

8. The control system of claim 4, wherein the signal transiting device (3) includes a global positioning system (GPS) module (37) electrically connected to the central process unit (31), and the GPS module (37) provides GPS function to the mobile device (2).

9. The control system of claim 8, wherein the GPS module (37) includes a gyro (371), and the mobile device (2) executes inertial navigation function via the GPS module (37).

10. A control system for controlling a mobile device of an automobile, includes:
a mobile device (2) having a touch screen (21) for displaying an image (I1);
a vehicle monitor (11) of an automobile (1); and
a signal transiting device (3) connected to the mobile device (2) and the vehicle monitor (11), the signal transiting device (3) fetching the image (I1) displayed on the mobile device (2) and transmitting the fetched image (I1) to the vehicle monitor (11) to display;
wherein, the signal transiting device (3) produces a control signal (S1) and transmits the control signal (S1) to the mobile device (2) when the vehicle image (I1) displayed on the vehicle monitor (11) is selected remotely by using a remote control device (4), and the mobile device (2) executes functions according to the received control signal (S1).

11. The control system of claim 10, wherein the image (I1) includes a plurality of selectable icons C1, the control signal (S1) according to function of the selected icon C1.

12. The control system of claim 10, wherein the image (I1) displayed on the vehicle monitor (11) includes a hotkey area (111), and each hotkey of the hotkey area (111) is set with a corresponding specific function of the mobile device (2), the mobile device (2) executing the specific function when the hotkey of the hotkey area (111) is selected remotely.

13. The control system of claim 10, wherein the signal transiting device (3) includes:
a first connecting interface (32) electrically connected to the mobile device (2) for transmitting the image (I1) and the control signal (S1);
a central process unit (31) electrically connected to the first connecting interface (32) for receiving and processing the image (I1);
a second connecting interface (33) electrically connected to the central process unit (31), and the second connecting interface (33) electrically connected to the vehicle monitor (11) of the automobile (1) for transmitting the processed image (I1) to the vehicle monitor (11) to display;
a third connecting interface (34) electrically connected to the central process unit (31), and the third connecting interface (34) electrically connected to the vehicle monitor (11) of the automobile (1) for receiving an operating signal (S0) produced and outputted by the vehicle monitor (11); and
a forth connecting interface (35) electrically connected to the central process unit (31), the forth connecting interface (35) wirelessly receiving a remote control signal (S2) sent by the remote control device (4);
wherein, the vehicle monitor (11) outputs the operating signal (S0) when the image (I1) displayed on the vehicle monitor (11) is selected by the received remote control signal (S2), and the central process unit (31) receives the operating signal (S0) via the third connecting interface (34) to produce the control signal (S1) according to the content of the received operating signal (S0).

14. The control system of claim 13, wherein the signal transiting device (3) further includes a memory (36) electrically connected to the central process unit (31), the memory (36) storing a plurality of control programs (361) therein, each of the plurality of control programs (361) is corresponding to different type of mobile device, the signal transiting device (3) installing one of the plurality of control programs (361) to the mobile device (2) according to the type of the mobile device (2), and the control program (361) is used to fetch the image (I1) displayed on the mobile device (2).

15. The control system of claim 13, wherein the first connecting interface (32) is a universal serial bus (USB) interface, a Bluetooth interface or a WIFI interface.

16. The control system of claim 13, wherein the second connecting interface (33) is a RCA terminal, and the third connecting interface (34) is a universal asynchronous receiver/transmitter (UART) interface.

17. The control system of claim 13, wherein the forth connecting interface (35) is a wireless radio frequency (RF) interface.

18. The control system of claim 13, wherein the signal transiting device (3) includes a global positioning system (GPS) module (37) electrically connected to the central process unit (31), and the GPS module (37) provides GPS function to the mobile device (2).

19. The control system of claim 18, wherein the GPS module (37) includes a gyro (371), and the mobile device (2) executes inertial navigation function via the GPS module (37).
